(19) United States
(12) Patent Application Publication
(10) Pub. No.: US 2022/0184553 A1
(43) Pub. Date: Jun. 16, 2022

(54) COUNTERFLOW AIR CONTACTOR FOR MASS TRANSFER

(71) Applicant: Evapco, Inc., Taneytown, MD (US)

(72) Inventor: Jean-Pierre Libert, Frederick, MD (US)

(21) Appl. No.: 17/671,024

(22) Filed: Feb. 14, 2022

Related U.S. Application Data
(63) Continuation-in-part of application No. 17/490,493, filed on Sep. 30, 2021.
Application No. 17/490,493 is a continuation of application No. 16/751,113, filed on Jan. 23, 2020, now abandoned.
(60) Provisional application No. 62/829,384, filed on Apr. 4, 2019.
(60) Provisional application No. 62/795,865, filed on Jan. 23, 2019.

(51) Int. Cl. B01D 53/62; B01D 53/78

(52) U.S. Cl. CPC B01D 53/62; B01D 53/78; B01D 2251/304; B01D 2251/306; B01D 2251/604; B01D 2257/504; B01D 2258/06

(57) ABSTRACT

A device and method for removing pollutants from the air including a reaction unit containing a reaction fluid dispersion medium such as film fill, a reaction fluid distribution system for distributing an aqueous reaction solution over the reaction fluid dispersion medium, and an air mover, located above the reaction fluid distribution system and reaction fluid dispersion medium, for drawing or forcing air into the reaction unit to contact the sodium or potassium hydroxide. The pollutant in the air reacts with the aqueous reaction solution to form an aqueous reaction product thus removing the pollutant from the air. The device may include humidifiers to humidify the ambient air before it contacts the reaction fluid.

### BACKGROUND OF THE INVENTION

### Field of the Invention

The present invention relates to methods and devices for removing pollutants from the air through chemical reactions and mass transfer.

### Description of the Background

There are known processes for reacting ambient air with potassium hydroxide, sodium hydroxide, or other chemicals in order to separate carbon dioxide and other pollutants from the air. Such processes are described in several patents and articles, including Keith et al., US Pat. Pub. No. 2015/0336044, and Keith, I I et al., “An Air-Liquid Contactor for Large Scale Capture of CO2 from Air.

### SUMMARY OF THE INVENTION

The present invention is an improved device/system for removing pollutants from the air, including carbon dioxide. More specifically, there is described herein a counterflow air contactor and a combined crossflow/counterflow air contactor, both for improved mass transfer, greater pollutant removal, and lower energy consumption. Devices of the invention may be used to remove pollutants from the air, lower carbon footprint, or to further process the byproducts for other uses such as extracting oil from the ground, or using the carbon dioxide as a natural refrigerant.

Combined Crossflow/Counterflow Air Contactor

According to a first embodiment of the invention, a central reaction unit is flanked by humidifier units.

An air mover is preferably located atop the central reaction unit to draw air through the side of the humidifiers (crossflow), into a plenum of the central reaction unit, and up and out the top of the device (counterflow).

Splash fill is stacked within the humidifiers. ArchBar brand splash fill is preferred, but any splash fill medium is suitable for use in the humidifier, preferably having a structure configured to break up an aqueous solution into small droplets (preferably of a diameter of 10 mm or less, and more preferably 6 mm or less) while keeping the interacting air-side pressure drop less than 250 Pa. A water distribution system (preferably including header and spray nozzles or similar arrangement) is located at the top of the humidifiers to spray water over the splash fill. The water collects in a water collection basin at the bottom of the humidifiers and is pumped via pump and recirculation pipes back to the top of the unit for re-distribution over the splash fill. Any type of readily available water may be used according to the resources available, including but not limited to well water, municipal water, and saltwater.

Ambient air passes through the humidifier, over the splash fill, and the humidified air is drawn up through the plenum of the reaction unit by the fan.

Another spray header is located in the central reaction unit beneath the fan. An aqueous reaction fluid is pumped to the spray header and is sprayed over approximately 6-20 feet of mass transfer media, such as Evapco's EvaPak or EvapTech's TechClean brand film fills. The aqueous reaction fluid is selected according to the pollutant to be removed from the air. In the case of carbon dioxide removal, potassium hydroxide or sodium hydroxide are suitable solutions. In the case of sulfur dioxide, a high alkali content solution is suitable, for example a urea solution or sodium hydroxide. Citric acid is also suitable for removal of sulfur dioxide. A urea solution is also suitable for nitrogen dioxide removal. Sodium hydroxide solution is also suitable for chlorine gas and/or hydrogen sulfide removal. While various pollutants may be removed from the air using appropriate reaction fluids according to known reactions, the invention will be described with reference to non-limiting example of removing of carbon dioxide from air using sodium or potassium hydroxide.

Any film fill is suitable for use in the reaction unit, provided that it provides a support media to the aqueous reaction solution to spread out in a thin film which results in a high contact area with the interacting ambient air, preferably having a surface area to volume ratio of at least 124 square meters per cubic meter (38 ft²/ft³), and more preferably at least 210 m²/m³ (64 ft²/ft³). According to a further preferred embodiment, the film fill is selected/configured to keep the interacting air-side pressure drop less than 250 Pa.

When the ambient air contacts potassium or sodium hydroxide, a chemical reaction causes mass transfer of the carbon dioxide from the air to bond with the potassium or sodium hydroxide to form potassium or sodium carbonate and water. The film fill helps to foster the chemical reaction because the potassium or sodium hydroxide adheres to the fill for a short time where it can contact the air to induce the reaction.

The resulting potassium or sodium carbonate and unreacted hydroxide, which remain in liquid form, drop to the central unit basin and are then pumped back over the unit or out of the unit for use, further processing and/or disposal, as appropriate.

Highly efficient drift eliminators may optionally be installed over the spray system to minimize the entrainment of liquid droplets to the atmosphere.

The device is typically field-erected to achieve the large size desired for scale, but may be assembled in a factory on a smaller scale suitable for transport to an installation location.

The device preferably features a fiberglass structure, panels/sheathing and fans, but may be made of any material sufficiently resistant to the corrosive effects of highly caustic hydroxide and carbonate solutions. Basins are preferably made of 316 stainless steel or reinforced concrete, but may likewise be made of any material sufficiently resistant to the corrosive effects of highly caustic hydroxide and carbonate solutions.

Counterflow Air Contactor

According to another embodiment of the invention, a central reaction unit (the air contactor) includes an air mover preferably located atop the central unit to draw air through the bottom side of the central unit into a plenum of the central unit, and up and out the top of the device (counterflow).

Approximately 6-40 feet of film fill, preferably EvapPak or TechClean brand film fill, is stacked within the central reaction unit. Any film fill is suitable for use in the reaction unit provided that it provides a support media to the aqueous solution to spread out in a thin film which results in a high contact area with the interacting ambient air. The film fill preferably has a surface area to volume ratio of at least 124 square meters per cubic meter (38 ft²/ft³), and more preferably at least 210 m²/m³ (64 ft²/ft³). According to a further preferred embodiment, the film fill is selected/configured to keep the interacting air-side pressure drop less than 250 Pa. Ambient air is drawn up through the plenum of the air contactor by the fan.

A spray header is located in the central reaction unit beneath the fan. A suitable aqueous reaction solution, for example, potassium or sodium hydroxide in the case of carbon dioxide removal, is pumped to the spray header and is sprayed over the fill. While various pollutants may be removed from the air using appropriate reaction fluids according to known reactions, the invention will be described with reference to non-limiting example of removing of carbon dioxide from air using sodium or potassium hydroxide.

When the ambient air contacts the potassium or sodium hydroxide a chemical reaction causes mass transfer of the carbon dioxide from the air to bond with the potassium or sodium hydroxide to form potassium or sodium carbonate and water. The film fill helps to foster the chemical reaction because the potassium or sodium hydroxide adheres to the fill for a short time where it can contact the air to induce the reaction. The resulting potassium or sodium carbonate and unreacted hydroxide which remain in liquid form, drop to the central unit basin and are then pumped back over the unit, or out of the unit for use, further processing and/or disposal, as appropriate.

Highly efficient drift eliminators are optionally installed over the spray system to minimize the entrainment of liquid droplets to the atmosphere.

The device is typically field-erected to achieve the large size desired for scale, but may be factory-assembled on a smaller scale suitable for transport to an installation location.

The device preferably features a fiberglass structure, panels/sheathing and fans, but may be made of any material sufficiently resistant to the corrosive effects of highly caustic hydroxide and carbonate solutions. Basins are preferably made of 316 stainless steel or reinforced concrete, but may likewise be made of any material sufficiently resistant to the corrosive effects of highly caustic hydroxide and carbonate solutions.

Accordingly, there is provided according to the invention an air contactor configured for large-scale and continuous removal of carbon dioxide from ambient air having a tower frame located above a reaction fluid basin, a reaction fluid dispersion medium supported in the tower frame; a reaction fluid distribution system located in the tower frame and above the reaction fluid dispersion medium and configured to distribute a reaction fluid over the reaction fluid dispersion medium; a fan supported by the tower frame and configured to draw or force ambient air through the reaction fluid dispersion medium as the reaction fluid distribution system is distributing the reaction fluid over the reaction fluid dispersion medium; wherein the reaction fluid basin located beneath the tower frame is configured to catch a reaction product from a reaction between said reaction fluid and carbon dioxide in the ambient air as well as unreacted reaction fluid and wherein the reaction fluid distribution system and the reaction fluid dispersion medium are located beneath said fan.

There is further provided according to an alternative embodiment of the invention an air contactor wherein the tower frame defines a plenum beneath the fluid dispersion media, the air contactor further including two humidifier sections of the tower frame flanking the plenum, the two humidifier sections each including low pressure drop fill water dispersion media supported in the frame and a water distribution system located over the low pressure drop fill water dispersion media.

Additional features and details of the device may be seen in the following drawings.

### BRIEF DESCRIPTION OF THE DRAWINGS

FIG. 1 is a cross-sectional side view of an air contactor according to a first embodiment of the invention.

FIG. 2 is a cross-sectional front view of an air contactor according to the embodiment shown in FIG. 1.

FIG. 3 is a schematic plan view of an air contactor according to a second embodiment of the invention.

FIG. 4 is a cross-section elevation view of an air contactor according to the embodiment of FIG. 3.

FIG. 5 is an endwall elevation view of an air contactor according to the embodiment of FIGS. 3 and 4.

FIG. 6 is a cross-section elevation view of an air contactor according to a third embodiment of the invention.

Features in the attached drawings are numbered with the following reference numerals:

1 Air contactor module
3 Reaction unit
4 Air inlet
5 Water humidifiers
7 Air mover/fan
9 Inlet louvers
11 Plenum
13 Splash Fill
15 Water distribution system
17 Water header
19 Water spray nozzles
21 Water basin
23 Water circulation pumps
25 K/Na Hydroxide distribution system
27 Riser
29 Feed pipe
31 K/Na Hydroxide Header
33 K/Na Hydroxide spray nozzles
35 K/Na Carbonate basin
37 Film Fill
39 Drift Eliminators
43 Water supply pipe
47 Fan shroud
49 Fan deck
51 Safety railing
53 Corrugated sheathing/casing
55 Stairway

### DETAILED DESCRIPTION

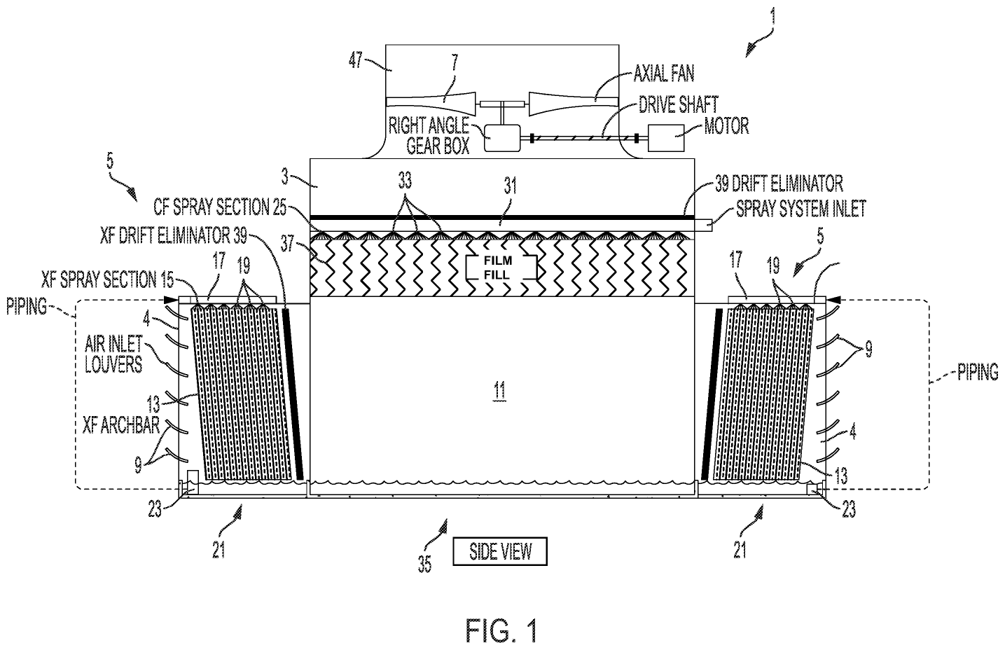

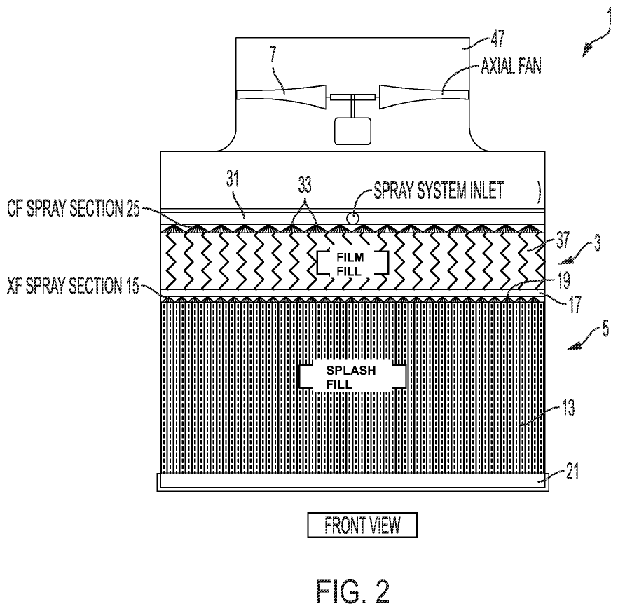

A first exemplary embodiment of the invention is shown in FIGS. 1 and 2. Air contactor 1 of this embodiment features a reaction unit 3 centrally located and flanked by humidifiers 5. A fan 7 or other air mover is situated atop the reaction unit 3 to draw air through air inlets 4 in the side of the humidifiers 5 via air inlet louvers 9 and into the plenum 11.

The humidifiers 5 are provided with splash fill 13, and a water distribution system 15 is located above the splash fill 13. The water distribution system 15 includes water header 17 and water spray nozzles 19, although any type of distribution system may be used. The bottom of the humidifiers 5 features a water collection basin 21 where the water distributed by the water distribution system 15 collects and is then pumped back to the water distribution system with water pump 23.

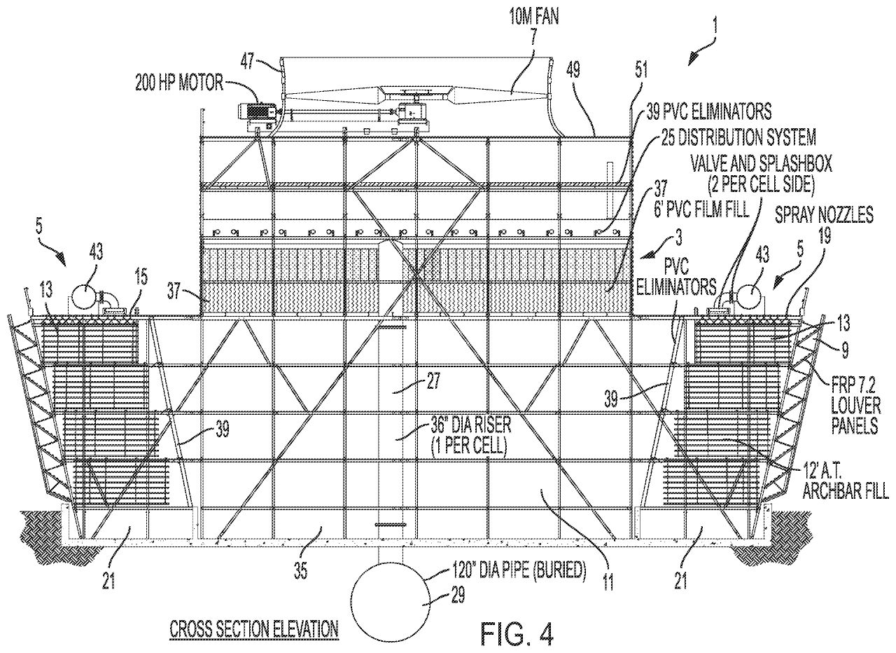

The reaction unit 3 includes plenum 11, which is laterally adjacent to the flanking humidifiers 5, over top of which is situated a section of film fill 37. A reaction fluid distribution system 25 is located above the section of film fill 37 for distributing a reaction fluid over the fill. While various pollutants may be removed from the air using appropriate reaction fluids according to known reactions, the invention will be described with reference to non-limiting example of removing of carbon dioxide from air using sodium or potassium hydroxide. The reaction fluid distribution system 25 includes header 31 and spray nozzles 33. The reaction fluid distribution system is fed by riser 27 from feed pipe 29 (See, e.g., FIG. 4).

The fan 7 draws air through the splash fill 13 in the humidifier sections 5 as the fill is wetted by the water distribution system 15; the air drawn by the fan then passes into the plenum 11 and up through the film fill 37 that is wetted by the reaction fluid distribution system 25 and out the top of the device. When the ambient air, humidified by the humidifiers 5, contacts the reaction fluid in the film fill section of the reaction unit 3, a chemical reaction causes a mass transfer of carbon dioxide in the air to bond with the potassium or sodium to form potassium carbonate or sodium carbonate and water. The resulting potassium carbonate or sodium carbonate and unreacted reaction fluid fall into the central basin 35 for further processing or disposal. Optional drift eliminators 39 may be situated between the splash fill 13 of the humidifiers 5 and the plenum 11 and/or above the reaction fluid distribution system 25.

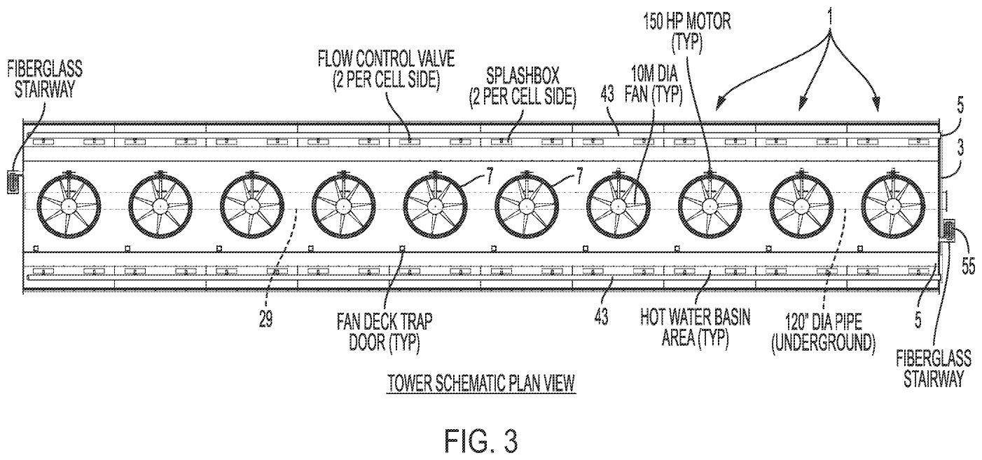

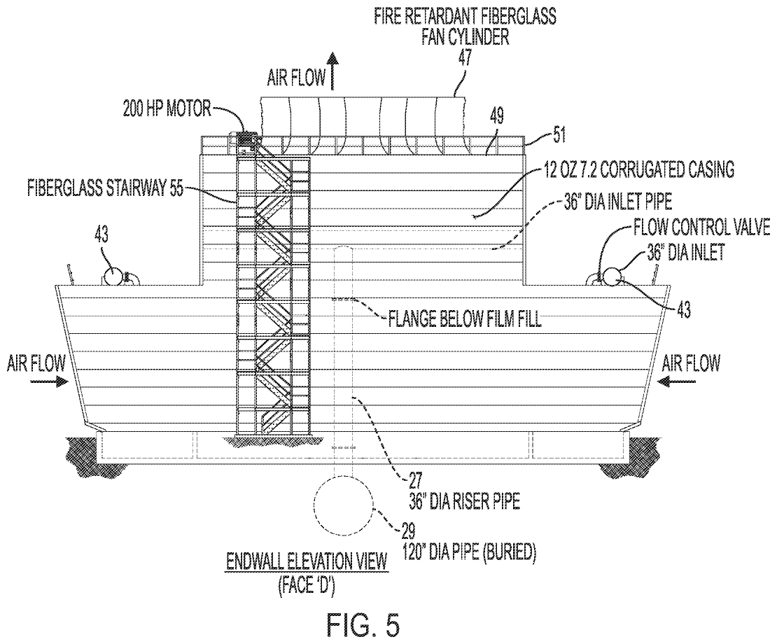

The device shown in FIGS. 1 and 2 is an individual module or “cell” containing a single reaction unit, which may be used standalone, or together with a plurality of other cells, as shown in FIGS. 3 through 5. According to the embodiment of FIGS. 3 through 5, the water basins 21 and the reaction fluid basin 35 each run the length of a plurality of cells. Additionally, a water supply pipe 43 runs along the top of each humidifier section providing water to the water distribution systems 15 of each cell. A reaction fluid supply pipe 29 is buried beneath the longitudinal axis of the center basin 35, and feeds reaction fluid to the reaction fluid distribution system 25 via riser 27. As shown in FIG. 5, the fan 7 is enclosed by a fan cylinder or shroud 47, the fan deck 49 is enclosed with a safety railing 51; the outside of the unit is clad in corrugated casing 51, and a stairway 55 may be provided to permit service access to the top of the unit.

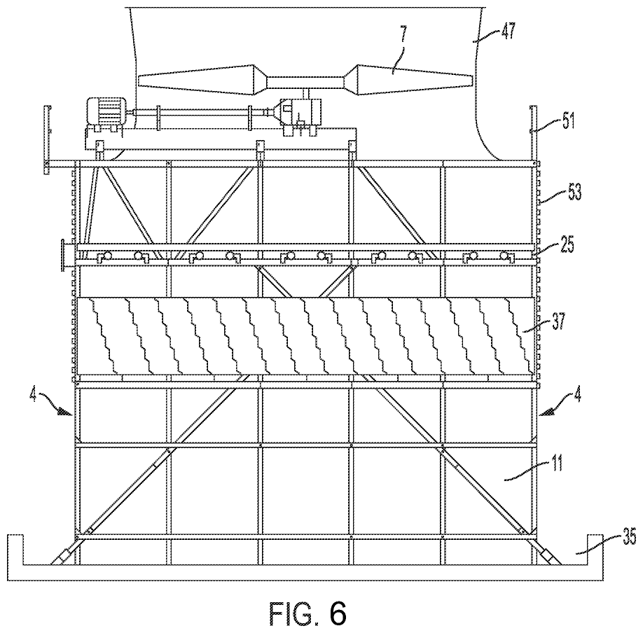

FIG. 6 shows an embodiment of the invention for use in locations where humidifiers are not necessary due to the normal humidity of the ambient air or where humidifiers are not economical due to a lack of water. According to this embodiment, no humidifiers are provided. The fan 7 draws ambient air directly into the plenum 11 of the reaction unit 3 up through a section of film fill 37 and out the top of the unit. Reaction fluid distribution system 25 distributes the reaction fluid over the fill 37 and the resulting carbonate and unreacted reaction fluid and water fall into the reaction fluid basin 35. Louvers 9 are provided at air inlets 4 to the plenum 11, and cladding or other sheathing is provided around the exterior of the fill section and the fluid distribution section.

1. An air contactor configured for large-scale and continuous removal of a pollutant from ambient air comprising:
a tower frame located above a reaction fluid basin,
a reaction fluid dispersion medium supported in said tower frame;
a reaction fluid distribution system located in said tower frame and above said reaction fluid dispersion medium and configured to distribute a reaction fluid over said reaction fluid dispersion medium;
a fan supported by said tower frame and configured to draw or force ambient air through said reaction fluid dispersion medium as said reaction fluid distribution system is distributing said reaction fluid over said reaction fluid dispersion medium;
said reaction fluid basin located beneath said tower frame and configured to catch a reaction product from a reaction between said reaction fluid and the pollutant in said ambient air as well as unreacted reaction fluid wherein said reaction fluid distribution system and said reaction fluid dispersion medium are located beneath said fan.

2. An air contactor according to claim 1, wherein said tower frame defines a plenum beneath a diameter of said fan, said air contactor further comprising two humidifier sections of said tower frame flanking said plenum, said two humidifier sections each comprising water dispersion media supported in said frame and a water distribution system located over said water dispersion media.

3. An air contactor according to claim 1, wherein said reaction fluid distribution system comprises a reaction fluid header connected to reaction fluid distribution pipes having spray nozzles connected thereto.

4. An air contactor according to claim 1, wherein the pollutant is carbon dioxide.

5. An air contactor according to claim 1, wherein the reaction fluid is selected from the group consisting of sodium hydroxide and potassium hydroxide.

6. An air contactor according to claim 1, wherein the tower frame and fan are fiberglass and the basins are hydroxide and carbonate corrosion resistant material.

7. An air contactor according to claim 1 wherein said reaction fluid dispersion medium is film fill.

8. An air contactor according to claim 2 wherein said water dispersion medium is splash fill.
